(19) United States
(12) Patent Application Publication
(10) Pub. No.: US 2011/0178195 A1
(43) Pub. Date: Jul. 21, 2011

(54) COMPOSITIONS FOR ABRASION RESISTANT FOAMS AND METHODS FOR MAKING THE SAME

(75) Inventor: Stephen Y. Cheng, Hong Kong (CN)

(73) Assignee: Dow Global Technologies LLC, Midland, MI (US)

(21) Appl. No.: 13/120,590

(22) PCT Filed: Oct. 2, 2009
(86) PCT No.: PCT/US2009/059315

§ 371 Date: Mar. 23, 2011

Related U.S. Application Data
(60) Provisional application No. 61/102,507, filed on Oct. 3, 2008.

(51) Int. Cl. C08J 9/35

(52) U.S. Cl. 521/134

(57) ABSTRACT

The invention provides a composition comprising at least the following components: A) an olefin-based polymer, B) a functionalized polydimethysiloxane, and C) a foaming agent comprising at least one organic compound.

### REFERENCE TO RELATED APPLICATIONS

This application claims the benefit of U.S. Provisional Application No. 61/102,507, filed on Oct. 3, 2008, and incorporated herein by reference.

### FIELD OF THE INVENTION

The invention relates to compositions for foams with improved abrasion resistance, and to methods for making the same. Such foams are particularly suitable for footwear components.

### BACKGROUND OF THE INVENTION

It is known that polydimethylsiloxane (PDMS) can be used to improve the abrasion resistance of plastic articles. See, for example, U.S. Pat. No. 6,767,931, U.S. Pat. No. 5,902,854 and WO2004087804A1.

U.S. Pat. No. 6,767,931 discloses a foamable polymer composition, which comprises the following: a1) a substantially random interpolymer produced from the following: i) one or more α-olefin monomers; and ii) one or more vinyl or vinylidene aromatic monomers and/or one or more sterically hindered aliphatic or cycloaliphatic vinyl or vinylidene monomers; and optionally iii) other polymerizable ethylenically unsaturated monomer(s); or a2) an interpolymer comprising polymerized units of ethylene and vinyl acetate; or a3) a combination of the polymers a1) and a2); and b) a polydiorganosiloxane having a viscosity of at least one million centistoke at 25° C.; and c) a foaming agent. The polydiorganosiloxane is useful for improving the abrasion resistance of foams comprising the substantially random interpolymer a1) and/or the ethylene/vinyl acetate interpolymer a2).

However, there remains a need for foam formulations of ultra low density that have improved abrasion resistance. This need is particularly required for the manufacture of footwear components, such as shoe inner soles and shoe outer soles, and especially shoe outer soles.

Thus, there is a need for improved (lower) foam densities, which translate to a potential cost reduction for the industry, and for comfortable foams for the consumer. There is a further need for foams that provide excellent abrasion resistance, equivalent to existing industry standard shoe sole foams.

This invention makes possible olefin-based polymer foams of specific gravity, or density, of 0.25 g/cm³ and lower, and an olefin-based polymer foam as low as 0.19 g/cm³. This is greater than a 30 percent reduction in foam density, compared with typical foams in the industry, for use in footwear outsoles, and where a typical abrasion resistance (Akron Abrasion, 6-pound load, 3000 cycles) requirement is 0.25 cm³ or less material loss. State of the art technology, used by global athletic footwear brands, manufacture foams of densities no less than about 0.28 g/cm³, while conventional outsole foam densities are around 0.32-0.38 g/cm³.

### SUMMARY OF THE INVENTION

The invention provides a composition comprising at least the following components:

A) an olefin-based polymer,

B) a functionalized polydimethysiloxane, and

C) a foaming agent comprising at least one organic compound.

### DETAILED DESCRIPTION OF THE INVENTION

As discussed above, the invention provides a composition comprising at least the following components:

A) an olefin-based polymer,

B) a functionalized polydimethysiloxane, and

C) a foaming agent comprising at least one organic compound.

In a preferred embodiment, the foaming agent has a decomposition temperature from 130° C. to 160° C.

In one embodiment, the functionalized polydimethylsiloxane is a hydroxyl-functionalized polydimethylsiloxane. In a further embodiment, the hydroxyl-functionalized polydimethylsiloxane is a hydroxyl-terminated polydimethylsiloxane.

In one embodiment, the polydimethylsiloxane has viscosity of at least one million centistokes at 25° C.

In one embodiment, the foaming agent has a decomposition temperature from 130° C. to 150° C.

In one embodiment, the at least one organic compound has at least one carbon-nitrogen bond.

In one embodiment, the at least one organic compound has at least two carbon-nitrogen bonds.

In one embodiment, the at least one organic compound has at least three carbon-nitrogen bonds.

In one embodiment, the at least one organic compound has at least four carbon-nitrogen bonds.

In one embodiment, the at least one organic compound has a molecular weight of greater than, or equal to, 100 g/mole, preferably greater than, or equal to, 110 g/mole.

In one embodiment, the at least one organic compound is a formamide.

In one embodiment, the at least one organic compound is an azobisformamide.

In one embodiment, the foaming agent is a hydroxyl-modified azobisformamide.

In one embodiment, component A is present in an amount greater than, or equal to, 10 weight percent, preferably greater than, or equal to, 20 weight percent, more preferably greater than, or equal to, 50 weight percent, based on the total weight of the polymer components of the composition.

In one embodiment, component A is present in an amount greater than, or equal to, 10 weight percent, preferably greater than, or equal to, 20 weight percent, more preferably greater than, or equal to, 50 weight percent, based on the total weight of the composition.

In one embodiment, component A is present in an amount greater than, or equal to, 60 weight percent, based on the total weight of the polymer components of the composition.

In one embodiment, component A is present in an amount greater than, or equal to, 60 weight percent, based on the total weight of the composition.

In one embodiment, component A is present in an amount greater than, or equal to, 70 weight percent, based on the total weight of the polymer components of the composition.

In one embodiment, component A is present in an amount greater than, or equal to, 70 weight percent, based on the total weight of the composition.

In one embodiment, component A is present in an amount greater than, or equal to, 80 weight percent, based on the total weight of the polymer components of the composition.

In one embodiment, component A is present in an amount greater than, or equal to, 80 weight percent, based on the total weight of the composition.

In one embodiment, component B is present in an amount from 2 to 5 weight percent, based on the weight of the composition.

In one embodiment, component C is present in an amount from 1 to 3 weight percent, based on the weight of the composition.

In one embodiment, the olefin-based polymer of Component A is an ethylene-based polymer.

In one embodiment, the ethylene-based polymer is an ethylene/α-olefin interpolymer. In a further embodiment, the α-olefin is a C3-C10 α-olefin. In a further embodiment, the α-olefin is propylene, 1-butene, 1-hexene or 1-octene.

In one embodiment, the ethylene/α-olefin interpolymer is a homogeneously branched linear ethylene/α-olefin interpolymer, or a homogeneously branched substantially linear ethylene/α-olefin interpolymer. In a further embodiment, the ethylene/α-olefin interpolymer is a homogeneously branched substantially linear ethylene/α-olefin interpolymer.

In one embodiment, the ethylene-based polymer has a density from 0.86 g/cc to 0.91 g/cc (1 cc=1 cm³).

In one embodiment, the ethylene-based polymer has a melt index (12) from 0.2 to 30 g/10 min.

In one embodiment, the olefin-based polymer is an olefin multi-block interpolymer. In a further embodiment, the olefin multi-block interpolymer, is an ethylene multi-block interpolymer

In one embodiment, the olefin multi-block interpolymer has a density from 0.86 g/cc to 0.91 g/cc.

In one embodiment, the olefin multi-block interpolymer has a melt index (12) from 0.2 to 15 g/10 min.

In one embodiment, the olefin-based polymer is a propylene-based polymer. In a further embodiment, the propylene-based polymer, is a propylene/ethylene interpolymer

In one embodiment, the propylene-based polymer has a density from 0.85 g/cc to 0.91 g/cc.

In one embodiment, the propylene-based polymer has a melt flow rate (MFR at 230° C.) from 2 to 25 g/10 min.

In one embodiment, an inventive composition further comprises an ethylene vinyl acetate copolymer.

In one embodiment, an inventive composition further comprises at least one additive.

In one embodiment, an inventive composition further comprises at least one additive selected from the following: foaming reaction accelerators, crosslinking agents, processing aids, fillers, or combinations thereof.

In one embodiment, an inventive composition further comprises at least one additive selected from the following: foaming reaction accelerators, chemical foaming agent, crosslinking agents, processing aids, fillers, or combinations thereof.

In one embodiment, an inventive composition further comprises at least one additive selected from the following: zinc oxide, dicumylperoxide, stearic acid, zinc stearate, talc, calcium carbonate, or combinations thereof.

In one embodiment, an inventive composition further comprises at least one additive selected from the following: azobisformamide, zinc oxide, dicumylperoxide, stearic acid, zinc stearate, talc, calcium carbonate, or combinations thereof.

In one embodiment, the composition further comprises at least the following components:

a) from 0 to 100 parts, preferably from 55 to 100 parts, of an olefin-based polymer, preferably an ethylene-based polymer, and more preferably an ethylene/α-olefin interpolymer,
b) from 100 to 0 parts, preferably from 45 to 0 parts of an ethylene vinyl acetate,
c) from 0.5 to 1.5 parts of zinc oxide,
d) from 0.5 to 1 parts stearic acid,
e) from 0.8 to 1.2 parts of dicumylperoxide,
f) from 0 to 0.5 parts of a curing coagent,
g) from 1 to 4 parts of a chemical foaming agent, and
h) from greater than 0.5 parts, preferably from 1.5 to 1.75 parts, of an hydroxyl-terminated PDMS.

An inventive composition may comprise a combination of two or more embodiments as described herein.

An olefin-based polymer may comprise a combination of two or more embodiments as described herein.

An ethylene-based polymer may comprise a combination of two or more embodiments as described herein.

An olefin multi-block interpolymer may comprise a combination of two or more embodiments as described herein.

A propylene-based polymer may comprise a combination of two or more embodiments as described herein.

The invention also provides an article comprising at least one component formed from an inventive composition.

In one embodiment, the article is a foam. In a further embodiment, the foam has a density from 0.10 g/cc to 0.75 g/cc, preferably from 0.20 g/cc to 0.40 g/cc.

In one embodiment, the foam has a specific gravity less than, or equal to, 0.25, preferably less than, or equal to, 0.23, and more preferably less than, or equal to, 0.21.

In one embodiment, the foam has an Akron Abrasion Resistance less than, or equal to, 0.50, preferably less than, or equal to, 0.30, and more preferably less than, or equal to, 0.25 cm³ loss (BS 903:6 pound load, 3000 cycles).

In one embodiment, the foam has a DIN Abrasion Resistance less than, or equal to, 200, preferably less than, or equal to, 150, and more preferably less than, or equal to, 0.40 mm³ loss (BS EN 12770: 2000).

In one embodiment, the article is a footwear component. In a further embodiment, the footwear component is a shoe outer sole.

An inventive foam may comprise a combination of two or more embodiments as described herein.

An inventive article may comprises a combination of two or more embodiments as described herein.

### Olefin-Based Polymers

Suitable olefin-based polymers include, but are not limited to, ethylene-based polymers, such as ethylene/α-olefin interpolymers, ethylene/propylene/diene interpolymers, ethylene/propylene copolymers, ethylene homopolymers; and propylene-based polymers such as, propylene homopolymers, propylene interpolymers, propylene/ethylene copolymers; olefin multi-block interpolymers (for example, ethylene/α-olefin multi-block interpolymers); natural rubber; polybutadiene rubber; butyl rubber; and blends thereof.

### Ethylene-Based Polymers

Suitable ethylene-based polymers include, but are not limited to, ethylene/α-olefin interpolymers, ethylene/propylene/diene interpolymers, ethylene/propylene polymers, and ethylene homopolymers.

Suitable ethylene-based polymers fall into four main classifications: (1) highly-branched; (2) heterogeneous linear; (3) homogeneously branched linear; and (4) homogeneously branched substantially linear. Respective polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers typically have a density from about 0.910 g/cc to about 0.940 g/cc, as measured by ASTM D-792-00.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers typically have a density from about 0.880 g/cc to about 0.940 g/cc. Preferably, the LLDPE is an interpolymer of ethylene and one or more other alpha olefins having from 3 to 18 carbon atoms, more preferably from 3 to 8 carbon atoms. Preferred α-olefins include propylene, 1-butene, 4-methyl-1-pentene, 1-hexene, and 1-octene, and preferably propylene, 1-butene, 1-hexene and 1-octene, and more preferably 1-butene, 1-hexene and 1-octene.

Ultra-low density polyethylene and very low density polyethylene are known interchangeably. These polymers typically have a density from about 0.870 g/cc to about 0.910 g/cc. High density ethylene polymers are generally homopolymers with a density typically from 0.955 g/cc to about 0.970 g/cc.

The terms “homogeneous” and “homogeneously-branched” are used in reference to an ethylene/α-olefin interpolymer, in which the α-olefin comonomer is randomly distributed within a given polymer molecule, and all of the polymer molecules have the same or substantially the same comonomer(s)-to-ethylene ratio. The homogeneously branched ethylene interpolymers that can be used in the practice of this invention include homogeneously branched linear ethylene interpolymers, and homogeneously branched substantially linear ethylene interpolymers.

Included amongst the homogeneously branched linear ethylene interpolymers are ethylene polymers, which lack long chain branching (or measurable amounts of long chain branching), but do have short chain branches, derived from the comonomer polymerized into the interpolymer, and which are homogeneously distributed, both within the same polymer chain, and between different polymer chains. That is, homogeneously branched linear ethylene interpolymers lack long chain branching, just as is the case for the linear low density polyethylene polymers or linear high density polyethylene polymers, and can be made using uniform branching distribution polymerization processes, as described, for example, by Elston in U.S. Pat. No. 3,645,992. Commercial examples of homogeneously branched linear ethylene/α-olefin interpolymers include TAFMER polymers supplied by the Mitsui Chemical Company, and EXACT polymers supplied by the ExxonMobil Chemical Company.

As discussed above, the homogeneously branched linear polymers are disclosed for example, by Elston in U.S. Pat. No. 3,645,992, and subsequent processes to produce such polymers using metallocene catalysts have been developed, as shown, for example, in EP 0 129 368, EP 0 260 999, U.S. Pat. No. 4,701,432; U.S. Pat. No. 4,937,301; U.S. Pat. No. 4,935,397; U.S. Pat. No. 5,055,438; and WO 90/07526; each fully incorporated herein by reference. The polymers can be made by conventional polymerization processes (for example, gas phase, slurry, solution, and high pressure).

The homogeneously branched substantially linear ethylene interpolymers used in the present invention are described in U.S. Pat. Nos. 5,272,236; 5,278,272; 6,054,544; 6,335,410 and 6,723,810; each fully incorporated herein by reference. The substantially linear ethylene interpolymers are those in which the comonomer is randomly distributed within a given interpolymer molecule, and in which all of the interpolymer molecules have the same or substantially the same comonomer(s)/ethylene ratio. In addition, the substantially linear ethylene interpolymers are homogeneously branched ethylene interpolymers having long chain branching (chain branch has more carbon atoms than a branched formed by the incorporation of one comonomer into the polymer backbone). The long chain branches have the same comonomer distribution as the polymer backbone, and can have about the same length as the length of the polymer backbone. “Substantially linear,” typically, is in reference to a polymer that is substituted, on average, with 0.01 long chain branches per 1000 carbons to 3 long chain branches per 1000 carbons.

Some polymers may be substituted with 0.01 long chain branches per 1000 carbons to 1 long chain branch per 1000 carbons, or from 0.05 long chain branches per 1000 carbons to 1 long chain branch per 1000 carbons, or from 0.3 long chain branches per 1000 carbons to 1 long chain branch per 1000 carbons. Commercial examples of substantially linear polymers include the ENGAGE Polyolefin Elastomers and AFFINITY Polyolefin Plastomers (both available from The Dow Chemical Company).

The substantially linear ethylene interpolymers form a unique class of homogeneously branched ethylene polymers. They differ substantially from the well-known class of conventional, homogeneously branched linear ethylene interpolymers, described by Elston in U.S. Pat. No. 3,645,992, and, moreover, they are not in the same class as conventional heterogeneous, “Ziegler-Natta catalyst polymerized” linear ethylene polymers (for example, ultra low density polyethylene (ULDPE), linear low density polyethylene (LLDPE) or high density polyethylene (HDPE), made, for example, using the technique disclosed by Anderson et al., in U.S. Pat. No. 4,076,698); nor are they in the same class as high pressure, free-radical initiated, highly branched polyethylenes, such as, for example, low density polyethylene (LDPE), ethylene-acrylic acid (EAA) copolymers and ethylene vinyl acetate (EVA) copolymers.

The homogeneously branched, substantially linear ethylene interpolymers useful in the invention have excellent processability, even though they have a relatively narrow molecular weight distribution. Surprisingly, the melt flow ratio (I₁₀/I₂), according to ASTM D 1238-04, of the substantially linear ethylene interpolymers can be varied widely, and essentially independently of the molecular weight distribution (M_{w}/Mₙ or MWD). This surprising behavior is completely contrary to conventional homogeneously branched linear ethylene interpolymers, such as those described, for example, by Elston in U.S. Pat. No. 3,645,992, and heterogeneously branched “conventional Ziegler-Natta polymerized” linear polyethylene interpolymers, such as those described, for example, by Anderson et al., in U.S. Pat. No. 4,076,698. Unlike the substantially linear ethylene interpolymers, linear ethylene interpolymers (whether homogeneously or heterogeneously branched) have rheological properties, such that, as the molecular weight distribution increases, the I₁₀/I₂ value also increases.

“Long chain branching (LCB)” can be determined by conventional techniques known in the industry, such as ¹³C nuclear magnetic resonance (¹³C NMR) spectroscopy, using, for example, the method of Randall (Rev. Micromole. Chem. Phys., 1989, C29 (2&3), p. 285-297). Two other methods are gel permeation chromatography, coupled with a low angle laser light scattering detector (GPC-LALLS), and gel permeation chromatography, coupled with a differential viscometer detector (GPC-DV). The use of these techniques for long chain branch detection, and the underlying theories, have been well documented in the literature. See, for example, Zimm, B. H. and Stockmayer, W. H., J. Chem. Phys., 17, 1301 (1949), and Rudin, A., Modern Methods of Polymer Characterization, John Wiley & Sons, New York (1991) pp. 103-112.

Homogeneously-branched substantially linear ethylene polymers include interpolymers of ethylene with at least one C3-C20 alpha-olefin. Optionally other polyene monomers, such as dienes or trienes are included. These polymers generally have a density between about 0.85 g/cc and about 0.96 g/cc. Preferably, the density is from 0.855 g/cc to 0.95 g/cc, more preferably, from 0.86 g/cc to 0.93 g/cc.

In contrast to “homogeneously branched substantially linear ethylene polymer,” the term “homogeneously branched linear ethylene polymer” means that the polymer lacks measurable or demonstrable long chain branches, that is, the polymer is substituted with an average of less than 0.01 long chain branch per 1000 carbons.

The homogeneous branched ethylene polymers useful in the present invention will preferably have a single melting peak, as measured using Differential Scanning calorimetry (DSC), in contrast to heterogeneously branched linear ethylene polymers, which have two or more melting peaks, due to the heterogeneously branched polymer's broad branching distribution.

In a preferred embodiment of the invention, an ethylene-based interpolymer is an ethylene/α-olefin interpolymer, comprising at least one α-olefin. In another embodiment, the interpolymer further comprises at least one diene or triene. Preferred α-olefins contain from 3 to 20 carbon atoms, more preferably from 3 to 10 carbon atoms, and are preferably propylene, 1-butene, 1-pentene, 1-hexene, 1-heptene or 1-octene, and more preferably, propylene, 1-butene, 1-hexene or 1-octene, and even more preferably 1-butene, 1-hexene or 1-octene. In a further embodiment, the ethylene/α-olefin interpolymer is an ethylene/α-olefin copolymer.

In one embodiment, the ethylene/α-olefin interpolymer has a molecular weight distribution (M_{w}/Mₙ) less than, or equal to, 5, preferably less than, or equal to, 4, and more preferably less than, or equal to, 3. In another embodiment, the ethylene/α-olefin interpolymer has a molecular weight distribution (M_{w}/Mₙ) greater than, or equal to, 1.1, preferably greater than, or equal to, 1.2, and more preferably greater than, or equal to, 1.5. In a further embodiment, the ethylene/α-olefin interpolymer is an ethylene/α-olefin copolymer.

In another embodiment, ethylene/α-olefin polymers have a molecular weight distribution from 1.1 to 5, and preferably from 1.2 to 4, and more preferably from 1.5 to 3. All individual values and subranges from 1.1 to 5 are included herein and disclosed herein. In a further embodiment, the ethylene/α-olefin interpolymer is an ethylene/α-olefin copolymer.

In another embodiment, the ethylene/α-olefin interpolymer has a melt index (I₂) less than, or equal to, 1000 g/10 min, preferably less than, or equal to 500 g/10 min, and more preferably less than, or equal to 100 g/10 min. In another embodiment, the ethylene/α-olefin interpolymer has a melt index (I₂) greater than, or equal to, 0.01 g/10 min, preferably greater than, or equal to 0.1 g/10 min, and more preferably greater than, or equal to 1 g/10 min. In a further embodiment, the ethylene/α-olefin interpolymer is an ethylene/α-olefin copolymer.

In another embodiment, the ethylene/α-olefin interpolymer has a melt index (I₂) from 0.05 g/10 min to 100 g/10 min, preferably from 0.1 g/10 min to 50 g/10 min, and more preferably from 0.2 g/10 min to 30 g/10 min, and even more preferably from 0.5 g/10 min to 20 g/10 min, as determined using ASTM D-1238-04 (190° C., 2.16 kg load). All individual values and subranges from 0.05 g/10 min to 300 g/10 min are included herein and disclosed herein. In a further embodiment, the ethylene/α-olefin interpolymer is an ethylene/α-olefin copolymer.

In another embodiment, the ethylene/α-olefin interpolymer has a melt index (I₂) less than, or equal to, 6 g/10 min, preferably less than, or equal to 5 g/10 min, and more preferably less than, or equal to 4 g/10 min. In another embodiment, the ethylene/α-olefin interpolymer has a melt index (I₂) greater than, or equal to, 0.01 g/10 min, preferably greater than, or equal to 0.05 g/10 min, and more preferably greater than, or equal to 0.1 g/10 min. In a further embodiment, the ethylene/α-olefin interpolymer is an ethylene/α-olefin copolymer.

In another embodiment, the ethylene/α-olefin interpolymer has a melt index (I₂) from 0.01 g/10 min to 4 g/10 min, preferably from 0.05 g/10 min to 3 g/10 min, and more preferably from 0.1 g/10 min to 2 g/10 min, as determined using ASTM D-1238-04 (190° C., 2.16 kg load). All individual values and subranges from 0.01 g/10 min to 4 g/10 min are included herein and disclosed herein. In a further embodiment, the ethylene/α-olefin interpolymer is an ethylene/α-olefin copolymer.

In another embodiment, the ethylene/α-olefin interpolymer has a density less than, or equal to, 0.93 g/cm³, preferably less than, or equal to, 0.92 g/cm³, and more preferably less than, or equal to, 0.91 g/cm³. In another embodiment, the ethylene/α-olefin interpolymer has a density greater than, or equal to, 0.85 g/cm³, preferably greater than, or equal to, 0.86 g/cm³, and more preferably greater than, or equal to, 0.87 g/cm³. In a further embodiment, the ethylene/α-olefin interpolymer is an ethylene/α-olefin copolymer.

In another embodiment, the ethylene/α-olefin interpolymer has a density from 0.85 g/cm³ to 0.93 g/cm³, preferably from 0.86 g/cm³ to 0.91 g/cm³, and more preferably from 0.88 g/cm³ to 0.91 g/cm³. All individual values and subranges from 0.85 g/cm³ to 0.93 g/cm³ are included herein and disclosed herein. In a further embodiment, the ethylene/α-olefin interpolymer is an ethylene/α-olefin copolymer.

An ethylene-base polymer may have a combination of two or more embodiments as described herein.

An ethylene/α-olefin interpolymer may have a combination of two or more embodiments as described herein.

An ethylene/α-olefin copolymer may have a combination of two or more embodiments as described herein.

### Olefin Multi-Block Interpolymers

The olefin multi-block interpolymers and their preparation and use, are described in WO 2005/090427, US2006/0199931, US2006/0199930, US2006/0199914, US2006/0199912, US2006/0199911, US2006/0199910, US2006/0199908, US2006/0199907, US2006/0199906, US2006/0199905, US2006/0199897, US2006/0199896, US2006/0199887, US2006/0199884, US2006/0199872, US2006/0199744, US2006/0199030, US2006/0199006 and US2006/0199983; each is fully incorporated herein by reference.

Olefin multi-block interpolymers may be made with two catalysts incorporating differing quantities of comonomer and a chain shuttling agent. Preferred olefin multi-block interpolymers are the ethylene/α-olefin multi-block interpolymers. An ethylene/α-olefin multi-block interpolymer, or ethylene/α-olefin multi-block copolymer, has one or more of the following characteristics:

(1) an average block index greater than zero and up to about 1.0 and a molecular weight distribution, Mw/Mn, greater than about 1.3; or

(2) at least one molecular fraction which elutes between 40° C. and 130° C. when fractionated using TREF, characterized in that the fraction has a block index of at least 0.5 and up to about 1; or

(3) an Mw/Mn from about 1.7 to about 3.5, at least one melting point, Tm, in degrees Celsius, and a density, d, in grams/cubic centimeter, wherein the numerical values of Tₘ and d correspond to the relationship:

Tₘ>−6553.3+13735(d)−7051.7(d)²; or

(4) an Mw/Mn from about 1.7 to about 3.5, and is characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or

(5) an elastic recovery, Re, in percent at 300 percent strain and 1 cycle measured with a compression-molded coated substrate of the ethylene/α-olefin interpolymer, and has a density, d, in grams/cubic centimeter, wherein the numerical values of Re and d satisfy the following relationship when ethylene/α-olefin interpolymer is substantially free of a cross-linked phase: Re>1481-1629(d); or

(6) a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/α-olefin interpolymer; or

(7) a storage modulus at 25° C., G′(25° C.), and a storage modulus at 100° C., G′(100° C.), wherein the ratio of G′(25° C.) to G′(100° C.) is in the range of about 1:1 to about 9:1.

In a further embodiment, the ethylene/α-olefin multi-block interpolymers are ethylene/α-olefin multi-block copolymers made in a continuous, solution polymerization reactor, and which possess a most probable distribution of block lengths. In one embodiment, the copolymers contain 4 or more blocks or segments including terminal blocks.

The ethylene/α-olefin multi-block interpolymers typically comprise ethylene and one or more copolymerizable α-olefin comonomers in polymerized form, characterized by multiple blocks or segments of two or more polymerized monomer units differing in chemical or physical properties. That is, the ethylene/α-olefin interpolymers are block interpolymers, preferably multi-block interpolymers or copolymers. In some embodiments, the multi-block copolymer can be represented by the following formula:

(AB)ₙ

where n is at least 1, preferably an integer greater than 1, such as 2, 3, 4, 5, 10, 15, 20, 30, 40, 50, 60, 70, 80, 90, 100, or higher, “A” represents a hard block or segment and “B” represents a soft block or segment. Preferably, the As and Bs are linked in a substantially linear fashion, as opposed to a substantially branched or substantially star-shaped fashion. In other embodiments, A blocks and B blocks are randomly distributed along the polymer chain. In other words, the block copolymers usually do not have a structure as follows.

AAA-AA-BBB-BB

In still other embodiments, the block copolymers do not usually have a third type of block, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The ethylene multi-block interpolymers typically comprise various amounts of “hard” and “soft” segments. “Hard” segments refer to blocks of polymerized units in which ethylene is present in an amount greater than about 95 weight percent, and preferably greater than about 98 weight percent based on the weight of the polymer. In other words, the comonomer content (content of monomers other than ethylene) in the hard segments is less than about 5 weight percent, and preferably less than about 2 weight percent based on the weight of the polymer. In some embodiments, the hard segments comprise all or substantially all ethylene. “Soft” segments, on the other hand, refer to blocks of polymerized units in which the comonomer content (content of monomers other than ethylene) is greater than about 5 weight percent, preferably greater than about 8 weight percent, greater than about 10 weight percent, or greater than about 15 weight percent based on the weight of the polymer. In some embodiments, the comonomer content in the soft segments can be greater than about 20 weight percent, greater than about 25 weight percent, greater than about 30 weight percent, greater than about 35 weight percent, greater than about 40 weight percent, greater than about 45 weight percent, greater than about 50 weight percent, or greater than about 60 weight percent.

The soft segments can often be present in a block interpolymer from about 1 weight percent to about 99 weight percent of the total weight of the block interpolymer, preferably from about 5 weight percent to about 95 weight percent, from about 10 weight percent to about 90 weight percent, from about 15 weight percent to about 85 weight percent, from about 20 weight percent to about 80 weight percent, from about 25 weight percent to about 75 weight percent, from about 30 weight percent to about 70 weight percent, from about 35 weight percent to about 65 weight percent, from about 40 weight percent to about 60 weight percent, or from about 45 weight percent to about 55 weight percent of the total weight of the block interpolymer. Conversely, the hard segments can be present in similar ranges. The soft segment weight percentage and the hard segment weight percentage can be calculated based on data obtained from DSC or NMR. Such methods and calculations are disclosed in a concurrently filed U.S. patent application Ser. No. 11/376,835 (insert when known), Attorney Docket No. 385063-999558, entitled “Ethylene/α-Olefin Block Interpolymers”, filed on Mar. 15, 2006, in the name of Colin L. P. Shan, Lonnie Hazlitt, et. al., and assigned to Dow Global Technologies Inc., the disclosure of which is incorporated by reference herein in its entirety.

The term “multi-block copolymer” or “segmented copolymer” refers to a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In a preferred embodiment, the blocks differ in the amount or type of comonomer incorporated therein, the density, the amount of crystallinity, the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property. The multi-block copolymers are characterized by unique distributions of both polydispersity index (PDI or M_{w}/Mₙ), block length distribution, and/or block number distribution due to the unique process making of the copolymers. More specifically, when produced in a continuous process, the polymers desirably possess PDI from 1.7 to 2.9, preferably from 1.8 to 2.5, more preferably from 1.8 to 2.2, and most preferably from 1.8 to 2.1. When produced in a batch or semi-batch process, the polymers possess PDI from 1.0 to 2.9, preferably from 1.3 to 2.5, more preferably from 1.4 to 2.0, and most preferably from 1.4 to 1.8.

An olefin multi-block interpolymer may have a combination of two or more embodiments as described herein.

An ethylene multi-block interpolymer may have a combination of two or more embodiments as described herein.

An olefin multi-block copolymer may have a combination of two or more embodiments as described herein.

An ethylene multi-block copolymer may have a combination of two or more embodiments as described herein.

### Propylene-Based Polymers

Suitable propylene-based polymers include propylene homopolymers and propylene interpolymers. Suitable comonomers for polymerizing with propylene include ethylene, 1-butene, 1-pentene, 1-hexene, 1-heptene, 1-octene, 1-nonene, 1-decene, 1-undecene, 1-dodecene, as well as 4-methyl-1-pentene, 4-methyl-1-hexene, 5-methyl-1-hexene, vinylcyclohexane, and styrene. The preferred comonomers include ethylene, 1-butene, 1-hexene, and 1-octene, and more preferably ethylene.

Optionally, the propylene-based polymer may comprise monomers having at least two double bonds, which are preferably dienes or trienes. Suitable diene and triene comonomers include 7-methyl-1,6-octadiene; 3,7-dimethyl-1,6-octadiene; 5,7-dimethyl-1,6-octadiene; 3,7,11-trimethyl-1,6,10-octatriene; 6-methyl-1,5-heptadiene; 1,3-butadiene; 1,6-heptadiene; 1,7-octadiene; 1,8-nonadiene; 1,9-decadiene; 1,10-undecadiene; norbornene; tetracyclododecene; or mixtures thereof; and preferably butadiene; hexadienes; and octadienes; and most preferably 1,4-hexadiene; 1,9-decadiene; 4-methyl-1,4-hexadiene; 5-methyl-1,4-hexadiene; dicyclopentadiene; and 5-ethylidene-2-norbornene (ENB).

Additional unsaturated comonomers include 1,3-butadiene, 1,3-pentadiene, norbornadiene, and dicyclopentadiene; C8-40 vinyl aromatic compounds including sytrene, o-, m-, and p-methylstyrene, divinylbenzene, vinylbiphenyl, vinylnapthalene; and halogen-substituted C8-40 vinyl aromatic compounds such as chlorostyrene and fluorostyrene.

The propylene-based interpolymers of particular interest include propylene/ethylene, propylene/1-butene, propylene/1-hexene, propylene/4-methyl-1-pentene, propylene/1-octene, propylene/ethylene/1-butene, propylene/ethylene/ENB, propylene/ethylene/1-hexene, propylene/ethylene/1-octene, propylene/styrene, and propylene/ethylene/styrene, and preferably propylene/ethylene interpolymer.

Suitable propylene-based polymers are formed by means within the skill in the art, for example, using single site catalysts (metallocene or constrained geometry) or

Ziegler Natta catalysts. The propylene and optional comonomers, such as ethylene, or alpha-olefin monomers, are polymerized under conditions within the skill in the art, for instance, as disclosed by Galli, et al., Angew. Macromol. Chem., Vol. 120, 73 (1984), or by E. P. Moore, et al., in Polypropylene Handbook, Hanser Publishers, New York, 1996, particularly pages 11-98. Propylene-based polymers include Shell's KF 6100 homopolymer polypropylene; Solvay's KS 4005 polypropylene copolymer; Solvay's KS 300 polypropylene terpolymer; and INSPIRE Performance Polymers available from The Dow Chemical Company. Additional propylene-based interpolymers include those described in U.S. Provisional Application No. 60/988,999 (filed Nov. 19, 2007), fully incorporated herein.

Propylene/α-olefin interpolymers, containing a majority weight percent (based on the weight of the interpolymer) polymerized propylene, fall within the invention. Suitable polypropylene base polymers include VERSIFY Plastomers and VERSIFY Elastomers (The Dow Chemical Company) and VISTAMAXX polymers (ExxonMobil Chemical Co.), LICOCENE polymers (Clariant), EASTOFLEX polymers (Eastman Chemical Co.), REXTAC polymers (Hunstman), VESTOPLAST polymers (Degussa), PROFAX PF-611 AND PROFAX PF-814 (Montell).

In one embodiment, the propylene-based polymers comprise propylene, and typically, ethylene, and/or one or more unsaturated comonomers, and are characterized as having at least one, preferably more than one, of the following properties: (i) ¹³C NMR peaks corresponding to a regio-error at about 14.6 and about 15.7 ppm, the peaks of about equal intensity, (ii) a skewness index, Six, greater than about −1.20, (iii) a DSC curve with a Tₘₑ that remains essentially the same, and a T_{Max} that decreases as the amount of comonomer (i.e., units derived from ethylene and/or the unsaturated comonomer(s)) in the interpolymer is increased, and (iv) an X-ray diffraction pattern that reports more gamma-form crystals than a comparable interpolymer prepared with a Ziegler-Natta catalyst. Preferably the propylene-based interpolymer is a propylene/ethylene interpolymer. Especially preferred propylene-based polymers are the VERSIFY Plastomers and VERSIFY Elastomers available from The Dow Chemical Company. It is noted that in property (i), the distance between the two 13C NMR peaks is about 1.1 ppm. These propylene-based interpolymers are made using a nonmetallocene, metal-centered, heteroaryl ligand catalyst (see U.S. Pat. No. 6,919,407). Such interpolymers are characterized by at least one, preferably at least two, more preferably at least three, and even more preferably all four, of these properties.

With respect to the X-ray property of subparagraph (iv) above, a “comparable” interpolymer is one having the same monomer composition within 10 weight percent, and the same M_{w} (weight average molecular weight) within 10 weight percent. For example, if an inventive propylene/ethylene/1-hexene interpolymer is 9 weight percent ethylene and 1 weight percent 1-hexene, and has a M_{w} of 250,000, then a comparable polymer would have from 8.1 to 9.9 weight percent ethylene, from 0.9 to 1.1 weight percent 1-hexene, and a M_{w} from 225,000 to 275,000, and prepared with a Ziegler-Natta catalyst.

In one embodiment, the propylene-based interpolymer has a melt flow rate (MFR) greater than, or equal to, 0.1, preferably greater than, or equal to 0.5, more preferably greater than, or equal to 2 g/10 min. In another embodiment, the propylene-based interpolymer has a melt flow rate (MFR) less than, or equal to, 100, preferably less than, or equal to 50, more preferably less than, or equal to 25 g/10 min. The MFR is measured according to ASTM D-1238 (2.16 kg, 230° C.). In a preferred embodiment, the propylene-based interpolymer is a propylene/ethylene interpolymer.

In one embodiment, the propylene-based interpolymer has a melt flow rate (MFR) from 0.1 to 100 g/10 min, preferably from 0.5 to 50 g/10 min, and more preferably from 2 to 25 g/10 min. All individual values and subranges from 0.1 to 100 g/10 min, are included herein and disclosed herein. The MFR is measured according to ASTM D-1238 (2.16 kg, 230° C.). In a preferred embodiment, the propylene-based interpolymer is a propylene/ethylene interpolymer.

In one embodiment, the propylene-based interpolymer has a density less than, or equal to, 0.92 g/cm³, preferably less than, or equal to, 0.91 g/cm³, and more preferably less than, or equal to, 0.90 g/cm³. In another embodiment, the propylene-based interpolymer has a density greater than, or equal to, 0.83 g/cm³, preferably greater than, or equal to, 0.84 g/cm³, and more preferably greater than, or equal to, 0.85 g/cm³. In a preferred embodiment, the propylene-based interpolymer is a propylene/ethylene interpolymer.

In one embodiment, the propylene-based interpolymer has a density from 0.83 g/cm³ to 0.92 g/cm³, and preferably from 0.84 g/cm³ to 0.91 g/cm³, and more preferably from 0.85 g/cm³ to 0.91 g/cm³. All individual values and subranges from 0.83 g/cm³ to 0.92 g/cm³, are included herein and disclosed herein. In a preferred embodiment, the propylene-based interpolymer is a propylene/ethylene interpolymer.

In one embodiment, the propylene-based interpolymer has a molecular weight distribution (M_{w}/Mₙ) less than, or equal to, 6, and preferably less than, or equal to, 5.5, and more preferably less than, or equal to 5. In another embodiment, the molecular weight distribution is greater than, or equal to, 1.5, preferably greater than, or equal to, 2, more preferably greater than, or equal to 2.5. In a preferred embodiment, the propylene-based interpolymer is a propylene/ethylene interpolymer.

In one embodiment, the propylene-based interpolymer has a molecular weight distribution from 1.5 to 6, and more preferably from 2 to 5.5, and more preferably from 2.5 to 5. All individual values and subranges from 1.5 to 6 are included herein and disclosed herein. In a preferred embodiment, the propylene-based interpolymer is a propylene/ethylene interpolymer.

In one embodiment, the propylene-based polymer comprises at least 50 weight percent polymerized propylene (based on the weight of the polymer) and at least 5 weight percent polymerized ethylene (based on the weight of the polymer), and has 13C NMR peaks, corresponding to a region error, at about 14.6 and 15.7 ppm, and the peaks are of about equal intensity (for example, see U.S. Pat. No. 6,919,407, column 12, line 64 to column 15, line 51, incorporated herein by reference).

A propylene-based polymer may have a combination of two or more embodiments as described herein.

A propylene/α-olefin interpolymer may have a combination of two or more embodiments as described herein.

A propylene/ethylene interpolymer may have a combination of two or more embodiments as described herein.

A propylene/ethylene copolymer may have a combination of two or more embodiments as described herein.

Other polymers that can be used in the inventive compositions include, but are not limited to, EEA (for example AMPLIFY EA 101 Functional Polymer available from The Dow Chemical Company); an EPDM (ethylene/propylene/diene terpolymer), such as NORDEL IP Hydrocarbon Rubbers from The Dow Chemical Company; an EVA (ethylene vinyl acetate copolymer), such as ELVAX product family from DuPont, an EMA (ethylene methacrylate) such as ELVALOY product family from DuPont; a SEBS such as KRATON G product family from KRATON Polymers LLC; a SBS (styrene-butadiene-styrene block copolymer), such as KRATON D product family from KRATON Polymers LLC; and an ionomer such as SURLYN product family from DuPont.

In one embodiment, an inventive composition comprises the following: (a) an ethylene/α-olefin interpolymer or olefin multi-block interpolymer (for example, an ethylene multi-block interpolymer), each having a density from 0.851 g/cc to 0.959 g/cc (1 cc=1 cm³), and melt index from 0.01 to 2000 dg/min at 190° C., 2 kg weight, (b) a hydroxyl functionalized PDMS (for example, a hydroxyl terminated PDMS), and (c) a maleic anhydride grafted ethylene/α-olefin interpolymer, an acrylic acid grafted ethylene/α-olefin copolymer, an imidizole grafted ethylene/α-olefin copolymer, a maleic anhydride grafted olefin multi-block interpolymer, an acrylic acid grafted olefin multi-block interpolymer, and/or an imidizole grafted olefin multi-block interpolymer. In a further embodiment, blend ratios (based on the weight of the composition) for the compositions would be from 50 to 99 percent component (a), from 0.5 to 49.5 weight percent component (b), and from 0.001 to 1 weight percent component (c). In a further embodiment, the above composition (blend A) can be further blended with other polymers, such as polypropylene homopolymer, propylene/α-olefin interpolymers, propylene/ethylene interpolymers, high density polyethylene, polyamide, ethylene vinyl acetate, ethylene vinyl acetate, ethylene ethyl acrylate, and the like. In a further embodiment, the blend ratios can be from 0.5 to 99.5 weight percent blend A and 99.5 to 0.5 weight percent of one or more of these other polymers.

In one embodiment, the invention provides a rigid TPO composition comprising the following: (a) a propylene/α-olefin interpolymer, a propylene/ethylene interpolymer, or a polypropylene homopolymer, each having a melt flow rate from 0.1 to 2000 dg/min at 230° C., 2 kg weight, (b) an ethylene/α-olefin interpolymer or olefin multi-block interpolymer (for example, an ethylene multi-block interpolymer), each having a density from 0.851 g/cc to 0.959 g/cc (1 cc=1 cm³), (c) a hydroxyl functionalized PDMS (for example, a hydroxyl terminated PDMS) and (d) a maleic anhydride grafted ethylene/α-olefin interpolymer, an acrylic acid grafted ethylene/α-olefin copolymer, an imidizole grafted ethylene/α-olefin copolymer, a maleic anhydride grafted olefin multi-block interpolymer, an acrylic acid grafted olefin multi-block interpolymer, and/or an imidizole grafted olefin multi-block interpolymer

In one embodiment, the composition comprises from 50 to 99 weight percent random or homopolymer polypropylene, and from 1 to 50 weight percent random or block polymer. In one embodiment, the polypropylene composition would comprise from 0 to 49.5 weight percent grafted polypropylene random or homopolymer (grafted function includes maleic anhydride, acrylic acid, and imidizole). In one embodiment, the composition comprises an ethylene/α-olefin interpolymer or an olefin multi-block interpolymer, from 0 to 49.5 weight percent of a grafted ethylene/α-olefin interpolymer or olefin multi-block interpolymer (grafted function includes maleic anhydride, acrylic acid, and imidizole). In a further embodiment, the composition would comprise from 0.001 to 1 weight percent of the hydroxyl functionalized PDMS.

### Polyolefin Blends

In one embodiment of the invention, a blend of two of more olefin-based polymers can be used in the inventive compositions. For example, a blend of two or more ethylene-based polymers, as discussed above; a blend of two or more propylene-based polymers, as discussed above; a blend of at least one ethylene-based polymer, as discussed above, and at least one propylene-based polymer, as discussed above; or combinations thereof. Additional blends include a blend of two or more olefin multi-block interpolymers, as discussed above; a blend of at least one ethylene-based polymer, as discussed above, and at least one olefin multi-block interpolymer, as discussed above; a blend of at least one propylene-based polymer, as discussed above, and at least one olefin multi-block interpolymer, as discussed above; a blend of at least one ethylene-based polymer, as discussed above, at least one propylene-based polymer, as discussed above, and at least one olefin multi-block interpolymer, as discussed above; or combinations thereof.

### Foaming Agents

The foaming agent can be a chemical or a physical foaming agent. Preferably, the foaming agent is a chemical foaming agent. Examples of chemical foaming agents include, but are not limited to, azodicarbonamide and azobisforamide. More preferably, the foaming agent will be a chemical foaming agent, having its activation temperature within the nominal crosslinking temperature profile.

In one embodiment, when the foaming agent is a chemical foaming agent, it is present in an amount between about 0.05 to about 10.0 phr, based on the amount of olefin-based polymer. More preferably, it is present between about 0.5 to about 5.0 phr, even more preferably, between about 1.5 to about 4.0 phr.

In a preferred embodiment, the foaming agent comprises at least two organic compounds.

In one embodiment, the chemical foaming agent comprises an azobisformamide. In a further embodiment, the foaming agent has a decomposition temperature from 130° C. to 160° C., preferably from 130° C. to 150° C.

All practically useful polymers to create the foams (POE, EVA, etc.) require processing temperatures around 90-125° C. This means that blowing agents should have decomposition temperatures above at least 130° C. A common inorganic blowing agent is sodium bicarbonate with optimum decomposition temperature above 160° C., but decomposition commences as low as 100° C. making its use in this invention not possible.

The decomposition temperature can be measured by DSC (Differential Scanning calorimetery), TGA (Thermogravimetric Analysis), DTA (Differential Thermal Analysis), or DSC-TGA. Suitable methods include ASTM D1715 and ASTM E1641-07. In one embodiment, ASTM D1715 is used to measure the decomposition temperature.

### Additives

An inventive composition may comprise one or more additives. Additives useful with the compositions of the present invention include, but are not limited to, curing coagents, scorch inhibitors, antioxidants, fillers, clays, processing aids, carbon black, flame retardants, peroxides, dispersion agents, waxes, coupling agents, mold release agents, light stabilizers, metal deactivators, plasticizers, antistatic agents, whitening agents, nucleating agents, other polymers, and colorants. The crosslinkable, expandable polymeric compositions can be highly filled.

Suitable non-halogenated flame retardant additives include alumina trihydrate, magnesium hydroxide, red phosphorus, silica, alumina, titanium oxides, melamine, calcium hexaborate, alumina, carbon nanotubes, wollastonite, mica, silicone polymers, phosphate esters, hindered amine stabilizers, ammonium octamolybdate, intumescent compounds, melamine octamolybdate, frits, hollow glass microspheres, talc, clay, organo-modified clay, zinc borate, antimony trioxide, and expandable graphite. Suitable halogenated flame retardant additives include decabromodiphenyl oxide, decabromodiphenyl ethane, ethylene-big (tetrabromophthalimide), and dechlorane plus.

Typically, polymers and resins used in the invention are treated with one or more stabilizers, for example, antioxidants, such as IRGANOX 1010 and IRGAFOS 168, both supplied by Ciba Specialty Chemicals. Polymers are typically treated with one or more stabilizers before an extrusion or other melt processes. Other polymeric additives include, but are not limited to, ultraviolet light absorbers, antistatic agents, pigments, dyes, nucleating agents, fillers, slip agents, fire retardants, plasticizers, processing aids, lubricants, stabilizers, smoke inhibitors, viscosity control agents, and anti-blocking agents.

### Applications

The inventive compositions are particularly useful in footwear, automotive, furniture, carpet and construction applications. Articles of manufacture include, but are not limited to, shoe soles, multicomponent shoe soles (including polymers of different densities and types), weather stripping, gaskets, profiles, durable goods, run flat tire inserts, construction panels, leisure and sports equipment foams, energy management foams, acoustic management foams, insulation foams, and other foams.

Various processes can be used to form an inventive article. Useful processes include, but are not limited to, injection molding, extrusion, compression molding, rotational molding, thermoforming, blow molding, powder coating, fiber spinning, and calendaring. Polymer compositions may be mixed in a variety of apparatuses, including, but not limited to, a batch mixer, a Brabender mixer, a Busch mixer, a Farrel mixer, or an extruder.

The inventive foams can be used in the following applications: (a) outsoles, midsoles and stiffners, to be assembled with standard polyurethane adhesive systems currently used by footwear industry, (b) painting of soles and mid-soles with polyurethane paints, currently used by footwear industry, and (c) over-molding of polyolefins and bi-component polyurethanes for multilayered soles and midsoles. In addition, polyolefin/polyurethane blends can be used in other applications, such as automotive applications and construction applications. Automotive applications include, but are not limited to, the manufacture of bumper fascias, vertical panels, soft TPO skins, interior trim. Construction applications include, but are not limited to, the manufacture of furniture and toys.

### DEFINITIONS

Any numerical range recited herein, includes all values from the lower value to the upper value, in increments of one unit, provided that there is a separation of at least two units between any lower value and any higher value. As an example, if it is stated that a compositional, physical or mechanical property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated in this specification. For ranges containing values which are less than one, or containing fractional numbers greater than one (for example, 1.1, 1.5, etc.), one unit is considered to be 0.0001, 0.001, 0.01 or 0.1, as appropriate. For ranges containing numbers less than ten (for example, 1 to 5), one unit is typically considered to be 0.1. These are only examples of what is specifically intended, and all possible combinations of numerical values between the lowest value and the highest value enumerated, are to be considered to be expressly stated in this application. Numerical ranges have been recited, as discussed herein, in reference to melt index, melt flow rate, molecular weight distribution, density, and other properties.

The term “composition,” as used herein, includes a mixture of materials which comprise the composition, as well as reaction products and decomposition products formed from the materials of the composition.

The terms “blend” or “polymer blend,” as used herein, mean a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “polymer,” as used herein, refers to a polymeric compound prepared by polymerizing monomers whether of the same or a different type. The generic term polymer thus embraces the term homopolymer, usually employed to refer to polymers prepared from only one type of monomer, and the term interpolymer as defined hereinafter. The terms “ethylene/α-olefin polymer” and “propylene/α-olefin polymer” are indicative of interpolymers as described below. As is known in the art, monomers are present in the polymer in polymerized forms.

The term “interpolymer,” as used herein, refers to polymers prepared by the polymerization of at least two different types of monomers. The generic term interpolymer thus includes copolymers (employed to refer to polymers prepared from two different monomers), and polymers prepared from more than two different types of monomers.

The term “olefin-based polymer,” as used herein, refers to a polymer that comprises a majority weight percent of a polymerized olefin, such ethylene or propylene, and based on the weight of the polymer.

The term, “ethylene-based polymer,” as used herein, refers to a polymer that comprises a majority weight percent of polymerized ethylene monomer (based on the weight of the polymer), and optionally may comprise at least one comonomer.

The term, “ethylene/α-olefin interpolymer,” as used herein, refers to an interpolymer that comprises a majority weight percent of polymerized ethylene monomer (based on the weight of the interpolymer), and at least one α-olefin. As used in the context of this disclosure, ethylene/α-olefin interpolymer excludes ethylene/α-olefin multi-block interpolymers.

The term, “ethylene/α-olefin copolymer,” as used herein, refers to a copolymer that has polymerized therein a majority weight percent ethylene (based on the weight of the copolymer), and an α-olefin. As used in the context of this disclosure, ethylene/α-olefin copolymer excludes ethylene/α-olefin multi-block copolymers.

The term, “propylene-based polymer,” as used herein, refers to a polymer that comprises a majority weight percent of polymerized propylene monomer (based on the weight of the polymer), and optionally may comprise at least one comonomer.

The term, “propylene/α-olefin interpolymer,” as used herein, refers to an interpolymer that comprises a majority weight percent of polymerized propylene monomer (based on the weight of the interpolymer), and at least one α-olefin. As used in the context of this disclosure, propylene/α-olefin interpolymer excludes propylene/α-olefin multi-block interpolymers.

The term, “propylene/ethylene interpolymer,” as used herein, refers to an interpolymer that comprises a majority weight percent of polymerized propylene monomer (based on the weight of the interpolymer), ethylene, and, optionally, at least one comonomer. As used in the context of this disclosure, propylene/ethylene interpolymer excludes propylene/ethylene multi-block interpolymers.

The term, “propylene/ethylene copolymer,” as used herein, refers to a copolymer that has polymerized therein a majority weight percent propylene (based on the weight of the copolymer), and ethylene. As used in the context of this disclosure, propylene/ethylene copolymer excludes propylene/ethylene multi-block copolymers.

The term functionalized polydimethylsiloxane, as used herein, refers to a polylmethylsiloxane that has chemically bonded therein at least one polar moiety, such as, for example, hydroxyl, carboxyl, amine, and/or the like. Preferred polar moieties include hydroxyl, carboxyl and amine, and more preferably hydroxyl.

The term “crosslinked foam,” as used herein, refers to a partially crosslinked foam (gel content less than 50 weight percent) or a fully crosslinked foam (gel content of 50 weight percent or more). Gel content is measured in accordance with ASTM D-2765-01, Procedure A. The gel content in an inventive foam is typically greater than 60 weight percent, based on the total weight of the foam.

The terms “thermal treatment” and “thermally treated,” and like terms, as used herein, refer to a process of increasing the temperature of a material or composition. Suitable means for increasing temperature include, but are not limited to, applying heat using an electrical heating source, or applying heat using a form of radiation.

### Measurements

By the term “MI,” is meant melt index, I₂, in g/10 min, measured using ASTM D-1238-04, Condition 190° C./2.16 kg for ethylene-based polymers. Condition 230° C./2.16 kg is used for propylene-based polymers, and designated as MFR (melt flow rate)).

Reported polymer densities were measured according to ASTM D-792-00.

Density for a foam specimen was measured according to ASTM D-297-93. After the foams are prepared, they were left to cool at room temperature for at least 24 hours before any testing is conducted. A piece of foam of approximate dimensions “1 cm×1 cm” was cut, and weighted on an analytical balance. The foam specimen was then dipped into alcohol and blotted dry, a procedure which aided in removing air bubbles in the subsequent submersion into water. Finally the specimen was submersed into a beaker of water, and held under water with a metallic weight, and weighed. The weight of the beaker of water and metallic weight was measured.

Density was calculated according to the following equation:

Density at 25° C. in Mg/m³=0.9971×A/(A−(B−C)), where

A=mass of specimen in grams

B=mass of specimen in beaker of water and metallic weight

C=mass of beaker of water and metallic weight

Hardness (Asker C) was measured according to ASTM D-2240-05, using a Teclock GS-701 N testing device. Each sample was conditioned for a minimum of 12 hours before testing, preferably, 7 days or more after production. Conditioning occurred at 23+/−2 degrees Celsius and humidity of 50+/−1%. For each measurement, the test specimens had a minimum thickness of 6 mm, and the surface area was “5 cm×5 cm.” The tests were performed at the conditioning conditions, and at a minimum of 12 mm from any edge of the specimen. The specimen was skinned, the measurements were taken with the skin on top of the plate and centered. The hardness scale was measured about 10 seconds after applying the pressure. The average of five measurements was reported, with the five measurements taken at different positions on the specimen, with at least 6 mm distance between each measurement site.

DIN abrasion resistance was measured in accordance with the procedures in BS EN 12770:2000. Test equipment used to perform the test was a GT-7012-D unit, which conformed to the equipment described in the test method, and available from GOTECH, a well-known equipment supplier in Taiwan for the testing of footwear and rubber materials. The test sample was drilled from the center of the foam sample (approximate dimensions 220 mm×220 mm×12 mm), which was created as described in the next section. The drilled sample took on the shape of a cylinder with a diameter of 16 mm, and the same thickness of the original foam slab of approximately 12 mm. The weight of the foam cylinder was taken prior to loading into the test equipment. The equipment was set to exert a 10N load on the sample, at a 90 degree contact angle to the abraded surface. The test equipment was then initiated, which ran the cylindrical sample back and forth across the abraded surface for a total of 40 m distance. The sample was then removed, and the weight of the sample taken. The volume of material loss due to abrasion was calculated by the following equation:

Volume loss in mm³=(weight prior to testing−weight after testing)×nominal abrasive power/(density of specimen×average abrasive power). The density of the sample was determined separately by ASTM D297-93 on the original 150 mm×150 mm×15 mm sample slab. The nominal abrasive power is a constant taken to be 200 mg, and the average abrasive power was determined from standards (supplied by GOTECH), and run prior to testing the foam samples. The standards typically yield abrasive losses close to 200 mg, typically around 190-210 (average abrasive power), which is intended to provide an indication of the condition of the test equipment.

### Experimental

The following examples illustrate, but do not, either explicitly or by implication, limit the present invention.

### Materials

The materials used in this study were the following.

EO 56 is a homogeneously branched substantially linear ethylene-butene copolymer (from The Dow Chemical Company) of the following characteristics: melt index (190° C., 2.16 kg load) from 1.5 to 2.5 g/10 min, and a density from 0.882 to 0.888 g/cc (cc=cm³).

EO 86 is a homogeneously branched substantially linear ethylene-butene copolymer (from The Dow Chemical Company) of the following characteristics: <0.5 g/10 min melt index at 190° C., 2.16 kg load, and a density from 0.898 to 0.904 g/cc.

ENGAGE 8840 Polyolefin Elastomer is an ethylene-octene copolymer (from The Dow Chemical Company) of the following characteristics: melt index (190° C., 2.16 kg load) from 1.2 to 2 g/10 min, and a density from 0.895 to 0.898 g/cc.

ENGAGE 7447 Polyolefin Elastomer is an ethylene-butene copolymer (from The Dow Chemical Company) of the following characteristics: melt index (190° C., 2.16 kg load) from 4 to 6 g/10 min, and a density from 0.862 to 0.868 g/cc.

ENGAGE 8407 Polyolefin Elastomer is an ethylene-octene copolymer (from The Dow Chemical Company) of the following characteristics: melt index (190° C., 2.16 kg load) from 22.5 to 37.5 g/10 min, and a density from 0.867 to 0.873 g/cc.

AMPLFY EA 101 Functional Polymer is an ethylene-ethylacrylate copolymer (from The Dow Chemical Company) of the following characteristics: melt index (190° C., 2.16 kg load) from 5 to 7 g/10 min, and a density from 0.929 to 0.933 g/cc.

ELVAX 462 is an ethylene-vinylacetate copolymer (from DuPont de Nemoir) of the following characteristics: a 21% vinylacetate content, with a 1.5 g/10 minutes melt-flow index at 190° C., 2.16 kg load, and a density of 0.941 g/cc.

Compounds for foam samples are commonly prepared in kneaders or roll mills to those familiar in the art. In this study, the ingredients for each foam formulation were compounded in a roll mill with 8-inch diameter rolls. Compounds were processed in the roll mill for about 8-10 minutes, at temperatures around 100° C.-110° C. The compounds were foamed by curing the formulation in a close mold of dimensions “140 mm×140 mm×8 mm,” at 170° C., for about 8 minutes, under ambient atmosphere.

The inventive formulation can be processed in the same manner that existing conventional formulations are processed in the footwear industry.

As shown in Table 1, the examples demonstrate the superior effectiveness of hydroxyl-terminated PDMS versus vinylidene-terminated PDMS in improving the abrasion resistance of crosslinked foams. The data in Table 1 demonstrate that Example 2, containing the hydroxyl terminated PDMS, affords the lowest loss of weight (therefore the best abrasion resistance) in the abrasion test amongst the 0.36-0.37 g/cm³ density foams.

TABLE 1

| Formulation | EX1 | EX 2 | EX 3 |
|---|---|---|---|
| EO 56 | 100 | 100 | 100 |
| EO 86 | 2 | | |
| HO-PMDS (1) | | 3.5 | |
| MB-50-020 unfunctionalized PMDS (2) | | | 3.5 |
| Talc | 12 | 10 | 10 |
| Zinc Oxide | 1 | 1 | 1 |
| Stearic Acid | 1 | 1 | 1 |
| Dicumylperoxide | 1 | 1 | 1 |
| FA 3 (foaming agent) (3) | 1.2 | 1.2 | 1.2 |
| Physical Properties of Crosslinked Foam | | | |
| Specific gravity (ASTM D297-93) | 0.37 | 0.37 | 0.36 |
| Skin Hardness, Asker C (ASTM D2240-05) | 71-73 | 70-72 | 69-71 |
| DIN Abrasion Resistance (mm³ loss) | 169 | 103 | 120 |
| (BS EN 12770: 2000) | | | |

(1) Hydroxyl-terminated PDMS in an ethylene/butene resin carrier, 50% active PDMS content.
(2) Unfunctionalized PDMS in LDPE from Dow Corning.
(3) FA 3 is an azobisformamide foaming agent with 201-203° C. decomposition temperature (for example, VINFOM AA100).

As shown in Table 2, the examples demonstrate the effectiveness of PDMS in combination with different foaming agents in foams prepared from an ethylene/α-olefin copolymer or an ethylene vinyl acetate.

TABLE 2

| Formulation | EX4 | EX 5 | EX 6 | EX7 | EX 8 |
|---|---|---|---|---|---|
| ENGAGE 8440 | 100 | 100 | 100 | | |
| ELVAX 462 | | | | 100 | 100 |
| HO-PMDS (1) | | 3.5 | 3.5 | | 3.5 |
| Calcium Carbonate | 10 | 10 | 10 | 10 | 10 |
| Zinc Oxide | 1.5 | 1.5 | 1.5 | 0.75 | 0.75 |
| Stearic Acid | 0.5 | 0.5 | 0.5 | 0.5 | 0.5 |
| Dicumylperoxide | 0.9 | 0.9 | 0.9 | 0.9 | 0.9 |
| TAC-50 (2) | 0.5 | 0.5 | 0.5 | | |
| FA 3 (foaming agent) (3) | 4 | 4 | | | |
| FA 4 (foaming agent) (4) | | | 4.5 | 3.0 | 3.2 |
| Physical Properties of | | | | | |
| Crosslinked Foams | | | | | |
| Specific gravity | 0.190 | 0.194 | 0.192 | 0.221 | 0.222 |
| (ASTM D297-93) | | | | | |
| Skin Hardness, | 59-61 | 60-62 | 61-63 | 60-62 | 60-62 |
| Asker C | | | | | |
| (ASTM D2240-05) | | | | | |
| DIN Abrasion Resistance | 306 | 148 | 138 | 407 | 163 |
| (mm³ loss) | | | | | |
| (BS EN 12770: 2000) | | | | | |
| Akron Abrasion | 0.93 | 0.28 | 0.22 | 1.98 | 0.43 |
| Resistance | | | | | |
| (cm³ loss) | | | | | |
| (BS 903: 6 pound load, | | | | | |
| 3000 cycles) | | | | | |

(1) Hydroxyl-terminated PDMS in an ethylene/butene resin carrier, 50 weight % active PDMS content.
(2) Triallyl cyanurate curing coagent, 50% active content of the cyanurate being 50 weight %, from Akzo Nobel.
(3) FA 3 is an azobisformamide foaming agent with 201-203° C. decomposition temperature (for example, VINFOM AA100).
(4) FA 4 is an azobisformamide foaming agent with 150° C. decomposition temperature (for example, VINFOM AA250H).

The data in Table 2 demonstrate that Examples 5 and 6, both containing the hydroxyl terminated PDMS material, showed differences in the abrasion resistance, depending on the chemical foaming agent used. However, both systems containing hydroxyl terminated PDMS were more abrasion resistant than the Example 4.

When an azobisformamide foaming agent (FA 4) with a lower decomposition temperature was used, a lower abrasion weight loss was observed (Example 6 versus Example 5). In particular the Akron Abrasion test performance for Inventive Example 6 exceeded the specifications for typical foamed outsoles (typically 0.25 cm³ (250 mm³) material abrasion loss under 6-pound load after 3000 abrasion cycles), even when produced at a density at least 30 percent lower than existing materials. Also, the very low density of the Example 6 is significantly lower than existing foams used in footwear applications.

The data for pure EVA foams shown in Examples 7 and 8 show that hydroxyl terminated PDMS is also effective for EVA systems. At similar levels of the hydroxyl terminated PDMS, the ethylene/α-olefin copolymer showed better abrasion resistance than EVA (compare Examples 6 and 8). Therefore, a blend containing POE and EVA would be expected to show better abrasion resistance than EVA alone, and the use of POE is preferred over EVA for improving abrasion resistance of the foam.

As shown in Table 3, the examples demonstrate the effectiveness of hydroxyl terminated PDMS in POE/EVA blends, with or without the use of silica as an abrasion resistant agent.

TABLE 3

| | | | | | | | EX | EX | | EX |
|---|---|---|---|---|---|---|---|---|---|---|
| Formulation | EX 9 | EX 10 | EX 11 | EX 12 | EX 13 | EX 14 | 15 | 16 | EX 17 | 18 |
| EO 56 | 15 | 15 | 15 | 15 | 15 | 15 | 15 | 15 | 20 | 15 |
| ENGAGE 7447 | 20 | 20 | 20 | 20 | 20 | 20 | 20 | 20 | 15 | 20 |
| EO 86 | 15 | 15 | 15 | 15 | 15 | 15 | 15 | 15 | 15 | 15 |
| ELVAX 462 | 50 | 50 | 50 | 50 | 50 | 50 | 50 | 50 | 50 | 50 |
| hydroxyl terminated | | | | | 3.5 | 3.5 | 3.5 | 3.5 | 3.5 | 5.0 |
| PDMS (1) | | | | | | | | | | |
| Silica (5) | | | 5 | 5 | | | 5 | 5 | | |
| Calcium carbonate | 10 | 10 | | 5 | 10 | 10 | | 5 | 10 | 10 |
| Zinc Oxide | 1.0 | 0.5 | 1.5 | 1.5 | 1.0 | 0.5 | 1.5 | 1.5 | 1.0 | 1.0 |
| Stearic Acid | 1.0 | 0.3 | 0.3 | 0.3 | 1.0 | 0.3 | 0.3 | 0.3 | 1.0 | 1.0 |
| Dicumylperoxide | 1.0 | 1.0 | 1.0 | 1.0 | 1.0 | 1.0 | 1.0 | 1.0 | 1.0 | 1.0 |
| FA 3 (3) | 2.0 | | | | 2.0 | | | | 2.0 | 2.0 |
| FA 4 (4) | | 2.5 | 2.5 | 2.5 | | 2.5 | 2.5 | 2.5 | | |
| Physical Properties of | | | | | | | | | | |
| Crosslinked Foams | | | | | | | | | | |
| Specific gravity | 0.30 | 0.31 | 0.31 | 0.30 | 0.31 | 0.33 | 0.29 | 0.29 | 0.25 | 0.31 |
| (ASTM D297) | | | | | | | | | | |
| Skin Hardness, | 64-66 | 63-65 | 65-67 | 62-64 | 62-64 | 65-67 | 62-64 | 61-63 | 65-67 | 65-67 |
| Asker C | | | | | | | | | | |
| (ASTM D2240) | | | | | | | | | | |
| DIN Abrasion | 346 | 348 | 343 | 479 | 93 | 80 | 103 | 116 | 103 | 87 |
| Resistance | | | | | | | | | | |
| (mm³ loss) | | | | | | | | | | |
| (BS EN 12770:2000) | | | | | | | | | | |
| Akron Abrasion | 0.31 | 0.30 | 0.66 | 0.83 | 0.08 | 0.06 | 0.08 | 0.10 | 0.08 | |
| Resistance | [310] | [300] | [660] | [830] | [80] | [60] | [80] | [100] | [80] | |
| (cm³ loss) [mm³ loss] | | | | | | | | | | |
| (BS 903: 6 | | | | | | | | | | |
| pound load, | | | | | | | | | | |
| 1000 cycles) | | | | | | | | | | |
| Akron Abrasion | 0.62 | | | | | | | | 0.25 | |
| Resistance | [620] | | | | | | | | [250] | |
| (cm³ loss) [mm³ loss] | | | | | | | | | | |
| (BS 903: 6 | | | | | | | | | | |
| pound load, | | | | | | | | | | |
| 3000 cycles) | | | | | | | | | | |

(5) HI-SIL 255 from PPG Industries. See Table 2 for a description of (1), (3) and (4).

As shown in Table 3, the hydroxyl-terminated PDMS is also effective for the formation of foams made from POE/EVA blends, as shown by comparison of the following sets of examples: “13 versus 9,” “14 versus 10,” “15 versus 11,” and “16 versus 12.” The inventive foams all showed marked improvements in the DIN and Akron abrasion resistance tests, at comparable, or lower densities. Also, silica, a material commonly used by the footwear industry as an “abrasion resistant improvement agent” for crosslinked foams, does not exhibit an abrasion resistance enhancement effect in Examples 11 and 12 over that of Examples 9 or 10. The superior abrasion resistance for compositions containing FA 4 (over FA 3), as a foaming agent, is also demonstrated here, as seen in the improved abrasion resistance of Example 14 over that of Example 13.

Unexpectedly, the enhanced abrasion resistance appears to be a function of the synergy between the foaming agent and the hydroxyl terminated PDMS, and not a function of the foaming agent alone. When the PDMS was not present (Examples 9 and 10), the abrasion resistance tests gave the same results as those for foams made with FA 3 and FA 4.

Table 4 shows the effectiveness of hydroxyl terminated PMDS in the formation of foams at higher densities, including blends of an ethylene/α-olefin copolymer and an ethylene ethylacrylate copolymer.

TABLE 4

| Formulation | EX 19 | EX 20 | EX 21 | EX 22 | EX 23 | EX 24 |
|---|---|---|---|---|---|---|
| EO 56 | 70 | 70 | 70 | 70 | | |
| ENGAGE 7447 | 30 | 30 | 30 | 30 | 40 | 40 |
| ENGAGE 8407 | | | | | 10 | 10 |
| AMPLIFY EA 101 | | | | | 50 | 50 |
| hydroxyl terminated PDMS(1) | | 3.5 | | 3.5 | | 3.5 |
| PDMS (MB-50-020(2)) | | | 3.5 | | | |
| Calcium carbonate | 10 | 10 | 10 | 10 | 10 | 10 |
| Zinc Oxide | 1.5 | 1.5 | 1.5 | 1.5 | 1.5 | 1.5 |
| Stearic Acid | 0.5 | 0.5 | 0.5 | 0.5 | 0.5 | 0.5 |
| Dicumylperoxide | 1.0 | 1.0 | 1.0 | 1.0 | 0.9 | 0.9 |
| TAC-50 | 0.3 | 0.3 | 0.3 | 0.3 | 0.3 | 0.3 |
| FA 3(3) | 1.5 | 1.5 | 1.5 | | 1.6 | 1.6 |
| FA 4(4) | | | | 1.7 | | |
| Physical Properties of | | | | | | |
| Crosslinked Foams | | | | | | |
| Specific gravity (ASTM D297) | 0.52 | 0.54 | 0.53 | 0.51 | 0.42 | 0.42 |
| Skin Hardness, Asker C | 67-69 | 66-68 | 67-69 | 65-67 | 68-70 | 68-70 |
| (ASTM D2240) | | | | | | |
| Abrasion Resistance | 353 | 73 | 152 | 70 | 344 | 108 |
| (mm³ loss) (BS ISO 4649-2002) | | | | | | |
| Abrasion Resistance | 1.26 | 0.24 | 0.41 | 0.21 | 1.08 | 0.24 |
| (cm³ loss) (BS 903: 6 pound load, | [1260] | [240] | [410] | [210] | [1080] | [240] |
| 3000 cycles) [mm³ loss] | | | | | | |

See Table 1 for a description of (1) and (2).
See Table 2 for a description of (3) and (4).

As shown in Table 4, the hydroxyl terminated PDMS is also effective in improving the abrasion resistance in higher density foams, as illustrated, for example, in the improvement in the abrasion resistance for Example 20 (which is a foam at about 0.5 g/cm³ density) over that of Example 19.

The unfunctionalized PDMS, which does not contain hydroxyl-termination, was less effective than the hydroxyl terminated PDMS. This is demonstrated in the difference in the abrasion resistance of Examples 20 and 21. Note also, the Akron Abrasion resistance of Example 21, containing the unfunctionalized PDMS, does not meet the typically required abrasion resistance requirement for outsole foams, as the Akron Abrasion is much greater than the requirement (<0.25 cm³ material loss, under a 6-pound load, after 3000 abrasive cycles).

The additional synergistic effect between the PDMS and the foaming agent FA 4 over that of FA 3 can be observed in these examples, as shown in the improvement of abrasion resistance of Example 22 over that of Example 20.

Examples 23 and 24 illustrate that the hydroxyl terminated PDMS is also effective for improving the abrasion resistance of foams made from POE/EEA blends.

It was unexpectedly discovered that the compositions containing the hydroxyl-terminated PDMS produced significantly better abrasion resistance for the crosslinked foams (which are especially suitable for soling applications), as compared to those compositions containing the unfunctionalized PDMS.

Also, when azobisformamide (FA 3) and azobisformamide (FA 4), with a lower decomposition temperature, were trialed in various formulations, and the results showed that foams produced from FA 4 had unexpectedly significantly better abrasion resistance than foams produced from FA 3.

In addition, blends of polyethylene/α-olefin elastomer (POE) and polyethylenevinylacetate (EVA), hydroxyl-terminated PDMS and azobisformamide were used to create foams with specific gravity as low as 0.25, Asker C Hardness of 66, and Akron Abrasion (6 pound load, 3000 cycles) material loss of 0.25 cm³. Furthermore, an even lighter foam of 0.19 g/cm³ density was made from an ethylene-octene copolymer of approximately 0.9 g/cm³ density, which had an Akron Abrasion (6 pound load, 3000 cycles) material loss of 0.22 cm³, while the reference foam, without PDMS, showed a material loss of 0.93 cm³, under the same test conditions. These foam densities were at least 30 percent lighter than those typically used in the industry, while maintaining, or exceeding, the abrasion resistance set by industry.

The hydroxyl-terminated PDMS, preferably combined with “lower decomposition temperature” azobisformamide foaming agent, allowed at least 30 percent weight savings for foamed outsoles, and achieved foam densities not practiced by the footwear industry today. Furthermore, the substitution of EVA with the ethylene/α-olefin polymers improved the abrasion resistance, even more, to afford properties superior to current materials used in shoe soles.

Thus, the hydroxyl-terminated PDMS and a preferred azobisformamide, having a low decomposition temperature, produced peroxide crosslinked foams of POE or EVA compositions with ultralow specific gravity of less than 0.25 g/cm³ for outsole applications, not practiced in the industry today.

It was discovered that hydroxyl-terminated polydimethylsiloxane was preferred over unfunctionalized polydimethylsiloxane for improving the abrasion resistance in crosslinked polyolefin foams. It was also discovered that the use of different foaming agents, such as different types of azobisformamide, with lower optimum decomposition temperatures, in combination with the presence of the polydimethylsiloxane, produced foams with significantly better abrasion resistance. These combined results allow for novel foams with ultra low densities, not currently achievable in the industry for footwear outsoles.

This inventive compositions may be applied to other foam applications requiring high abrasion resistance and low foam density, including, but not limited to, medical and ergonomic foams, equine and stock protective foams, grips and handles. The hydroxyl terminated PDMS may also be effective as an abrasion resistance enhancer in other non-foamed polyolefin applications.

While the invention has been described with respect to a limited number of embodiments, these embodiments are not intended to limit the scope of the invention, as otherwise described and claimed herein.

1. A composition comprising at least the following components:
A) an olefin-based polymer,
B) a functionalized polydimethysiloxane, and
C) a foaming agent comprising at least one organic compound.

2. The composition of claim 1, wherein the foaming agent has a decomposition temperature from 130° C. to 160° C.

3. The composition of claim 1, wherein the functionalized polydimethylsiloxane is a hydroxyl-functionalized polydimethylsiloxane.

4. The composition of claim 3, wherein the hydroxyl-functionalized polydimethylsiloxane is a hydroxyl-terminated polydimethylsiloxane.

5. The composition of claim 1, wherein the at least one organic compound has at least one carbon-nitrogen bond.

6. The composition of claim 1, wherein the at least one organic compound has a molecular weight of greater than, or equal to, 100 g/mole.

7. The composition of claim 1, wherein component B is present in an amount from 2 to 5 weight percent, based on the weight of the composition.

8. The composition of claim 1, wherein the olefin-based polymer is an ethylene/α-olefin interpolymer.

9. The composition of claim 8, wherein the interpolymer has a density from 0.86 g/cc to 0.91 g/cc.

10. The composition of claim 8, wherein the interpolymer has a melt index (12) from 0.2 to 30 g/10 min.

11. The composition of claim 1, further comprising an ethylene vinyl acetate copolymer.

12. An article comprising at least one component formed from the composition of claim 1.

13. The article of claim 12, wherein the article is a foam.

14. The article of claim 13, wherein the foam has a specific gravity less than, or equal to, 0.25.

15. The article of claim 13, wherein the foam has an Akron Abrasion Resistance less than, or equal to, 0.50 cm³ loss.
